(19) United States
(12) Patent Application Publication
(10) Pub. No.: US 2025/0296203 A1
(43) Pub. Date: Sep. 25, 2025

(54) RATCHET WRENCH

(71) Applicant: William Tools Co., Ltd., Taichung City (TW)

(72) Inventor: Shui-Lai Chiang, Taichung City (TW)

(21) Appl. No.: 18/893,007

(22) Filed: Sep. 23, 2024

(30) Foreign Application Priority Data
Mar. 21, 2024 (TW) 113110555

(51) Int. Cl. B25B 13/46

(52) U.S. Cl. CPC B25B 13/463

(57) ABSTRACT

A ratchet wrench is provided, wherein the ratchet wrench includes: a rod body including a working head having a chamber, and a handle; a ratchet member rotatably received in the chamber and including an assembling portion; a blocking member received in the chamber; a dial member inserted in the working head and including a body portion extending into the chamber and a toggle portion blocked on the working head, the body portion including an insertion hole and a receiving hole; a fixation member inserted in the insertion hole and including a hollowed portion elastically engaged with the body portion, the fixation member restricting the blocking member between the fixation member and an inner surface of the chamber; and an elastic urging mechanism received in the receiving hole and urging the blocking member so that the blocking member and the ratchet member are engaged with each other.

### BACKGROUND OF THE INVENTION

### Field of the Invention

The present invention relates to a hand tool, particularly to a ratchet wrench.

### Description of the Prior Art

Generally, during fastening operations, hand tools such as ratchet wrenches are often used to fasten fasteners, to achieve a labor-saving effect. For example, a socket wrench can be used to loosen/tighten bolts, nuts, etc. Alternatively, based on different driven members, a socket may be detachably connected to a driving head of a driving tool head.

Typically, a ratchet wrench includes a dial member for switching the rotation direction of the driving head, allowing for quick switching of the required driving direction. Conventionally, the ratchet wrench utilizes a solid member inserted into the dial member to retain and limit the blocking member which engages with the driving head. However, the conventional solid member cannot reliably engage with the inner surface of the insertion hole in the dial member, which can cause the solid member to move arbitrarily, resulting in poor retention of the blocking member. This leads to poor engagement between the blocking member and the driving head, thus affecting the performance of the ratchet wrench.

The present invention is, therefore, arisen to obviate or at least mitigate the above-mentioned disadvantages.

### SUMMARY OF THE INVENTION

The main object of the present invention is to provide a ratchet wrench which offers stable, good, and reliable retention of components, thereby improving the operational performance of the ratchet wrench.

To achieve the above and other objects, a ratchet wrench is provided, wherein the ratchet wrench includes: a rod body, two ends of the rod body respectively including a working head and a handle, the working head including a chamber; a ratchet member rotatably received in the chamber and including an assembling portion configured to be assembled with a driving member; a blocking member received in the chamber; a dial member inserted in the working head, the dial member including a body portion extending into the chamber and a toggle portion blocked on an outer side of the working head, the body portion including an insertion hole and a receiving hole; a fixation member inserted in the insertion hole and including a hollowed portion being elastically engaged with the body portion, the fixation member restricting the blocking member between the fixation member and an inner surface of the chamber; and an elastic urging mechanism received in the receiving hole and urging the blocking member so that the blocking member and the ratchet member are engaged with each other.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a perspective view of an exemplary embodiment of the present invention;

FIG. 2 is a partial exploded view of an exemplary embodiment of the present invention;

FIG. 3 is another partial exploded view of an exemplary embodiment of the present invention;

FIG. 4 is a first partial cross-sectional view of an exemplary embodiment of the present invention;

FIG. 5 is a second partial cross-sectional view of an exemplary embodiment of the present invention;

FIG. 6 is a third partial cross-sectional view of an exemplary embodiment of the present invention; and

FIGS. 7 to 8 are schematic views showing the cooperation between a dial member and a fixation member according to an exemplary embodiment of the present invention.

### DETAILED DESCRIPTION OF THE PREFERRED EMBODIMENTS

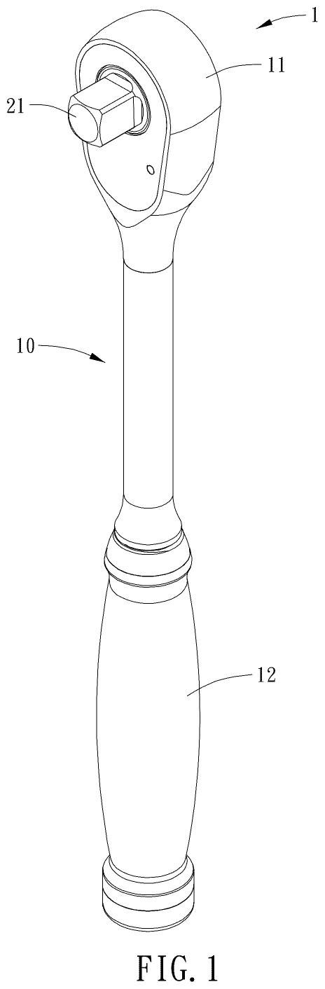

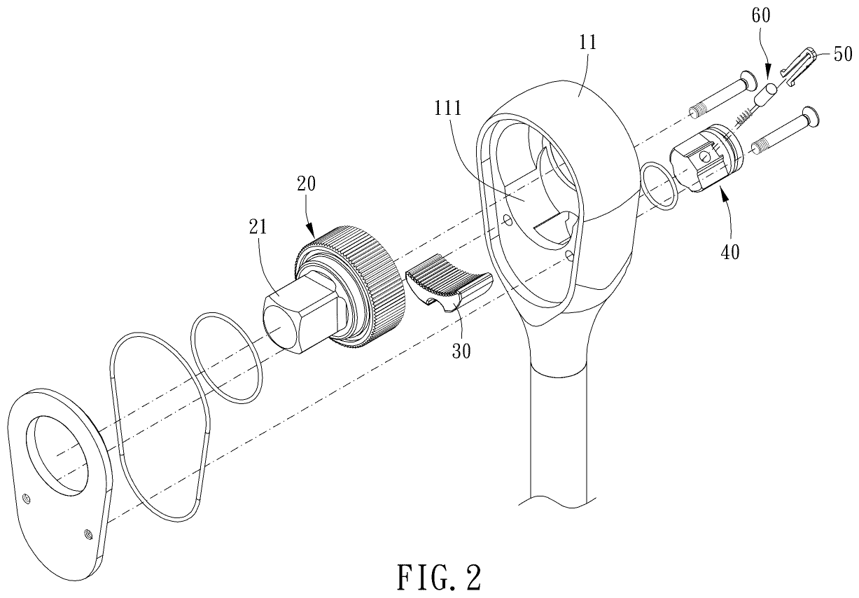

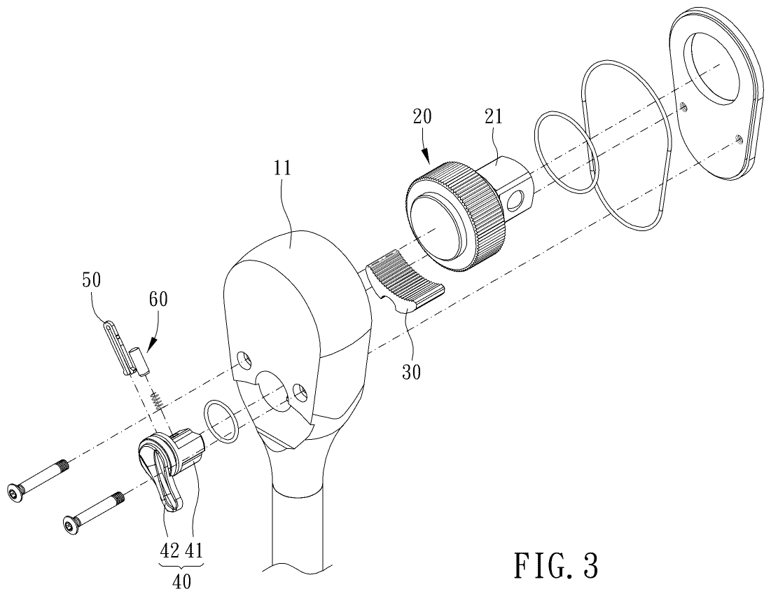

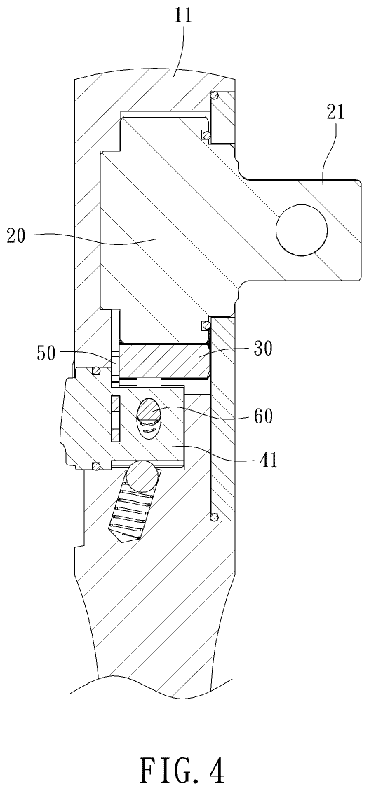

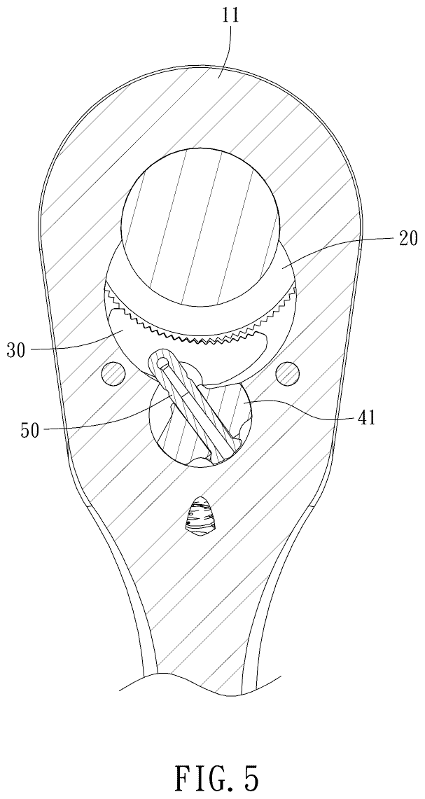

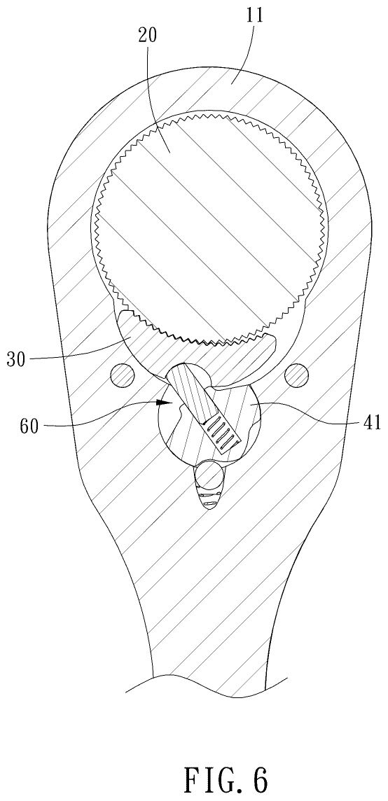

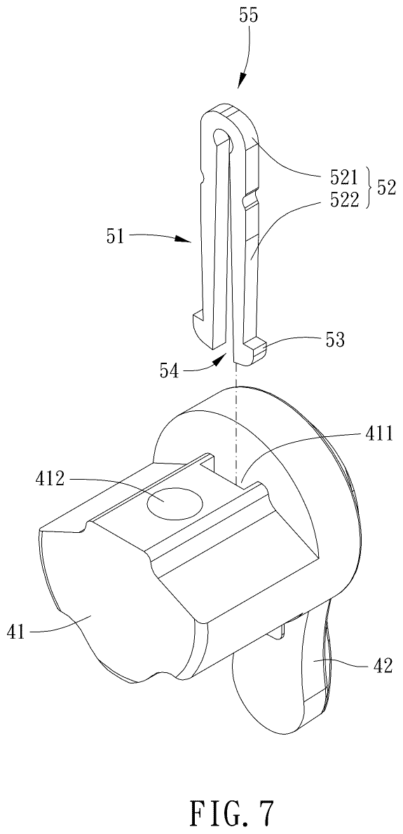

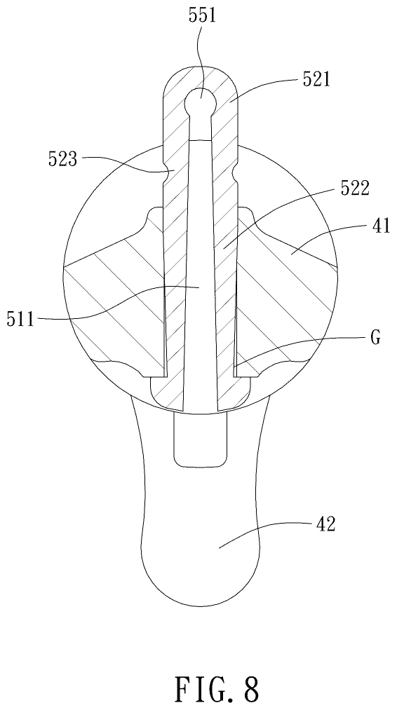

Please refer to FIGS. 1 to 8 for an exemplary embodiment of the present invention. A ratchet wrench 1 of the present invention includes a rod body 10, a ratchet member 20, a blocking member 30, a dial member 40, a fixation member 50, and an elastic urging mechanism 60.

Two ends of the rod body 10 include a working head 11 and a handle 12 respectively, and the working head 11 includes a chamber 111. The ratchet member 20 is rotatably received in the chamber 111, and the ratchet member 20 includes an assembling portion 21 (may be a protruding head or a recessed hole) configured to be assembled with a driving member (e.g., a socket, extension bar, tool head, etc.). The blocking member 30 is received in the chamber 111, and the blocking member 30 includes a plurality of blocking teeth configured to restrict the ratchet member 20 to unidirectional rotation. The dial member 40 is inserted in the working head 11, and the dial member 40 includes a body portion 41 extending into the chamber 111 and a toggle portion 42 blocked on an outer side of the working head 11. The body portion 41 includes an insertion hole 411 and a receiving hole 412. The fixation member 50 is inserted in the insertion hole 411, and the fixation member 50 includes a hollowed portion 51 elastically engaged with the body portion 41. The fixation member 50 restricts the blocking member 30 between the fixation member 50 and an inner surface of the chamber 111. The elastic urging mechanism 60 is received in the receiving hole 412 and elastically urges the blocking member 30 so that the blocking member 30 and the ratchet member 20 are engaged with each other.

The toggle portion 42 can be moved to drive the blocking member 30 to change the engagement direction between the blocking member 30 and the ratchet member 20, thereby switching the unidirectional rotation of the ratchet member 20. Additionally, the fixation member 50 can stably and elastically engage with the body portion 41 without arbitrary movement, effectively retaining the blocking member 30 in position, ensuring good and reliable engagement between the blocking member 30 and the ratchet member 20, thus improving the operational performance of the ratchet wrench 1.

Specifically, the fixation member 50 extends radially beyond more than 0.5 times a thickness of the blocking member 30, which increases the stability of the blocking member 30. The hollowed portion 51 includes a slot 511, and one end of the slot 511 is open on one side of the fixation member 50, which enhances the elastic engagement of the fixation member 50. Specifically, the fixation member 50 is generally Ω-shaped, and the fixation member 50 further includes a U-shaped body 52 and two engaging blocks 53 connected to the two ends of the U-shaped body 52. The U-shaped body 52 extends through the insertion hole 411 and elastically engages with the inner surface of the insertion hole 411, and the two engaging blocks 53 are positioned at one side of the body portion 41. This provides a stable and reliable configuration for the fixation member 50. The two engaging blocks 53 may be in surface contact with one side of the body portion 41 or may gradually taper into the insertion hole 411 and be partially inserted into the insertion hole 411, which can enhances the stability and fixation effect of the fixation member 50.

In this embodiment, the U-shaped body 52 includes a bending section 521 and two legs 522, each of the two legs 522 is connected to and between one of the two ends of the bending section 521 and one of the two engaging blocks 53, respectively. Between each of the two legs 522 and the bending section 521 is a thinned portion 523, which enhances the elastic deformation ability of the fixation member 50. The hollowed portion 51 further includes an open end 54, and the hollowed portion 51 gradually widens toward the open end 54, which allows the fixation member 50 a greater degree of elastic deformation, ensuring that the fixation member 50 elastically engages with the body portion 41. The hollowed portion 51 further includes a closed end 55, and the closed end 55 includes an enlarged hole 551, which enhances the elastic deformation ability of the fixation member 50. Preferably, the fixation member 50 gradually thins from the closed end 55 toward the open end 54, and there is a gap G between the portion of the fixation member 50 adjacent to the open end 54 and the inner surface of the insertion hole 411, which ensures that a portion of the fixation member 50 adjacent to the blocking member 30 contacts the inner surface of the insertion hole 411, thus providing a stronger and more effective restriction on the blocking member 30.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A ratchet wrench including:
a rod body, two ends of the rod body including a working head and a handle respectively, the working head including a chamber;
a ratchet member rotatably received in the chamber and including an assembling portion configured to be assembled with a driving member;
a blocking member received in the chamber;
a dial member inserted in the working head, the dial member including a body portion extending into the chamber and a toggle portion blocked on an outer side of the working head, the body portion including an insertion hole and a receiving hole;
a fixation member inserted in the insertion hole and including a hollowed portion elastically engaged with the body portion, the fixation member restricting the blocking member between the fixation member and an inner surface of the chamber; and
an elastic urging mechanism received in the receiving hole and urging the blocking member so that the blocking member and the ratchet member are engaged with each other.

2. The ratchet wrench of claim 1, wherein the fixation member extends radially beyond more than 0.5 times a thickness of the blocking member.

3. The ratchet wrench of claim 1, wherein the hollowed portion includes a slot, and one end of the slot is open on one side of the fixation member.

4. The ratchet wrench of claim 3, wherein the fixation member is generally Ω-shaped.

5. The ratchet wrench of claim 3, wherein the fixation member includes a U-shaped body and two engaging blocks connected to the two ends of the U-shaped body, the U-shaped body is disposed through the insertion hole and elastically engages with an inner surface of the insertion hole, and the two engaging blocks are positioned at one side of the body portion.

6. The ratchet wrench of claim 5, wherein the U-shaped body includes a bending section and two legs, each of the two legs is connected to and between one of the two ends of the bending section and one of the two engaging blocks, and between each of the two legs and the bending section is a thinned portion.

7. The ratchet wrench of claim 1, wherein the hollowed portion includes an open end, and the hollowed portion gradually widens toward the open end.

8. The ratchet wrench of claim 7, wherein the hollowed portion further includes a closed end, and the closed end includes an enlarged hole.

9. The ratchet wrench of claim 8, wherein the fixation member gradually thins from the closed end toward the open end.

10. The ratchet wrench of claim 7, wherein there is a gap between a portion of the fixation member adjacent to the open end and an inner surface of the insertion hole.
